(19) United States
(12) Patent Application Publication
(10) Pub. No.: US 2015/0355414 A1
(43) Pub. Date: Dec. 10, 2015

(54) MPO OPTICAL FIBER CABLE ADAPTER

(71) Applicant: OE-TEK INC., New Taipei City (TW)

(72) Inventor: Hsu-Chih Chen, New Taipei City (TW)

(21) Appl. No.: 14/321,609

(22) Filed: Jul. 1, 2014

(30) Foreign Application Priority Data
Jun. 10, 2014 (TW) 103119975

(51) Int. Cl. G02B 6/38

(52) U.S. Cl. CPC G02B 6/3807

(57) ABSTRACT

The present invention provides a MPO optical fiber cable adapter for connecting with two optical fiber cable connectors, comprising: an outer housing having an axial chamber; two axial ends of the axial chamber having an opening respectively; wherein outer side of the outer housing includes two protruding edges for securing the adapter onto an object; an inner housing disposed inside the axial chamber of the outer housing and having two locking hooks extended from left/right sides of each opening; upper and lower sides thereof having upper and lower inner walls opposite from each other; wherein inner sides of the upper and lower inner walls include upper and lower concave slots respectively; a polarity member attached to the upper and lower concave slots and configured to be detachably replaced by the user to allow the adapter to reveal different polarities; and a dust protective cover firmly attached to the openings.

### FIELD OF THE INVENTION

The present invention relates to a MPO optical fiber cable adapter, in particular, to a MPO optical fiber cable adapter allowing simple and fast changes of polarities based on the needs of the user.

### BACKGROUND OF THE INVENTION

In the modern era due to the demand of tremendous amount of information transmission, the development of optical fiber communication revolutionizes the method of information transmission. For an optical fiber cable, it typically includes a connector at its end, and an adapter is often used for containing the connectors in order to connect two optical fiber cables together and to allow the optical fiber cable sections to be extended. In addition, in terms of the polarities (orientations) of an optical fiber cable adapter, they can be generally categorized into two types of a Key-up-to-Key-down type and a Key-up-to-Key-up type; therefore, the user needs to identify the polarities of the optical fiber connectors correctly in order to purchase the proper optical fiber cable adapter.

However, the inventor discovers that the optical fiber cable adapters available on the market typically belong to one of the two types of the aforementioned adapters only; while most users often failed to identify the polarities of the adapters or have no clue of how to distinguish the polarities of the adapters. The problem caused by return or exchange of correct optical fiber adapters with repetitive confirmations on the correct polarities of adapters after buying a wrong one, happens repeatedly. Consequently, making right purchases on the correct adapters can be troublesome to both the buyer and the seller.

In view of the above, the inventor seeks to provide a solution capable of overcoming the aforementioned drawbacks as a primary objective of the present invention.

### SUMMARY OF THE INVENTION

A primary objective of the present invention is to provide a MPO optical fiber cable adapter, which is able to allow the adapter to reveal different polarities by changing the structure of the adapter and by providing a polarity member with detachable replacements; therefore, the problem associated with user's wrong purchases due to incorrect discrimination of the polarities of adapters can be overcome.

To achieve the aforementioned objective, the present invention provides a MPO optical fiber cable adapter for connecting with two optical fiber cable connectors, comprising: an outer housing having an axial chamber formed by a top wall, a bottom wall, a right-side wall and a left-side wall circumferencing together; two axial ends of the axial chamber having an opening formed thereon respectively; wherein the right-side wall and the left-side wall includes a protruding edge formed thereon respectively and used for securing the MPO optical fiber cable adapter onto an object; an inner housing disposed inside the axial chamber of the outer housing and having two locking hooks formed to extend from left and right two sides of each opening respectively; upper and lower sides thereof having an upper inner wall and a lower inner wall arranged opposite from each other; the upper inner wall and the lower inner wall as well as the plurality of locking hooks co-defining a rectangular receiving space together; wherein inner sides of the upper inner wall and the lower inner wall further include an upper concave slot and a lower concave slot formed thereon respectively; a polarity member having a width smaller than those of the upper concave slot and the lower concave slot and firmly attached to the upper concave slot and the lower concave slot, configured to be detachably replaced in parts by the user in order to allow the MPO optical fiber cable adapter is configured to reveal different polarities; and a dust protective cover firmly attached to the plurality of openings in order to prevent dust from entering therein; characterized in that, the user can replace polarity member freely according to the polarities of the plurality of optical fiber cable connectors in order to allow the MPO optical fiber cable adapter to fit with the polarities of the plurality of optical fiber cable connectors correspondingly.

In view of the above, a MPO optical fiber cable adapter of the present invention includes at least the following merits:

(1) Under the premise that there is no need for additional special or custom-made tools, the user can utilize the polarity member configured in the present invention to change the polarities of the MPO optical fiber cable adapter with ease and convenience according to the needs of the polarity of the optical fiber connector to be attached thereto.

(2) It is able to prevent the stock and storage of different types of optical fiber cable adapters and to overcome the problem associated with user's wrong purchases due to incorrect understanding and discrimination of the polarities of adapters.

### BRIEF DESCRIPTION OF THE DRAWINGS

FIG. 1 is a perspective view of conventional MPO type optical fiber connectors and conventional optical fiber cable adapters.

FIG. 2 is a perspective view of an embodiment of a MPO optical fiber cable adapter (with the polarity of Key-up-to-Key-down) of the present invention.

FIG. 3 is a perspective view of an embodiment of a MPO optical fiber cable adapter (with the polarity of Key-up-to-Key-up) of the present invention.

FIG. 4 is a perspective view of another embodiment of a MPO optical fiber cable adapter (with the polarity of Key-up-to-Key-down) of the present invention.

FIG. 5 is a perspective view of another embodiment of a MPO optical fiber cable adapter (with the polarity of Key-up-to-Key-up) of the present invention.

FIG. 6 is a perspective view of a MPO optical fiber adapter and MPO type optical fiber connectors.

### DESCRIPTION OF EMBODIMENTS OF THE INVENTION

To understand the objectives, features and effects of the present invention, the following detailed description of the embodiment of the present invention is provided along with the accompanied drawings to further describe the present invention in greater detail as follows.

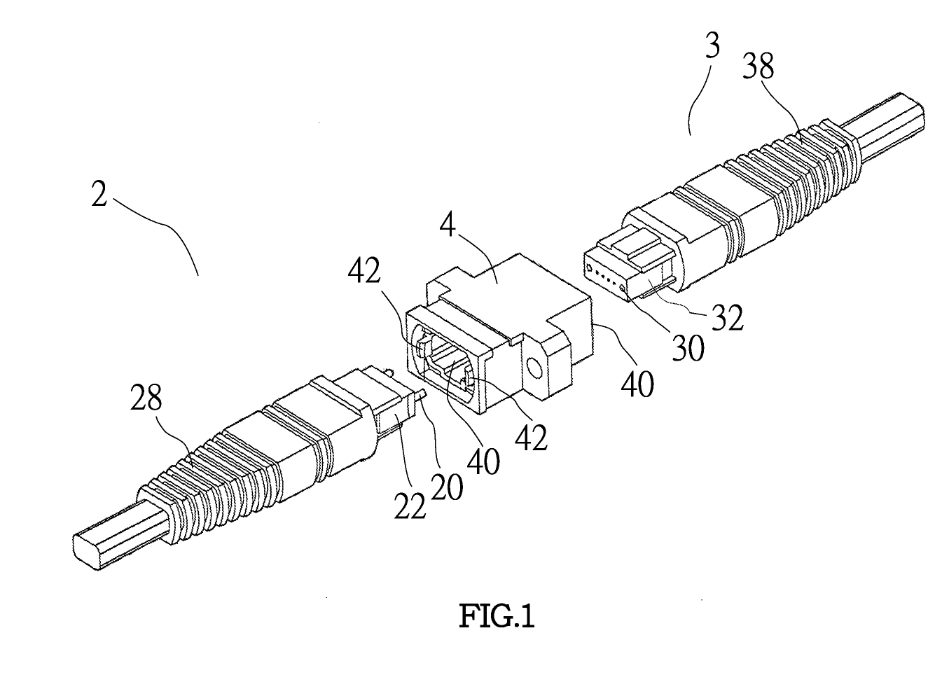

Referring to FIG. 1 showing a perspective view MPO type optical fiber connectors and conventional optical fiber cable adapters. When the user wishes to use a receiving space 40 of a conventional optical fiber cable adapter 4 to connect to the MPO type optical fiber cable connectors 2, 3, he or she may be uncertain about whether the polarities of the conventional optical fiber cable adapter 4 matches with those of the conventional MPO type optical fiber cable connectors 2, 3 for achieving the connection successfully. At this time, if their polarities do not match, then the user still tends to exert an external force on one boot 28 of the MPO type optical fiber cable connector 2 and one boot end 38 of the MPO type optical fiber cable connector 3 toward the direction of the conventional optical fiber cable adapter 4; however, since the two locking hooks 42 on the conventional optical fiber cable adapter 4 cannot be fitted firmly for locking onto the two concave portions 22 of the MPO type optical fiber cable connector 2 and the two concave portions 32 of the MPO type optical fiber cable connector 3 respectively, such engagements are prone to slip off easily. In addition, a guiding pin 20 of the MPO type optical fiber cable connector 2 cannot be inserted into a guiding hole 30 of the MPO type optical fiber cable connector 3 as well. Therefore, the user is likely to need to make another purchase of the optical fiber cable adapter after reconfirming the polarity, which can cause inconvenience and troubles to buyers and sellers to a considerable degree.

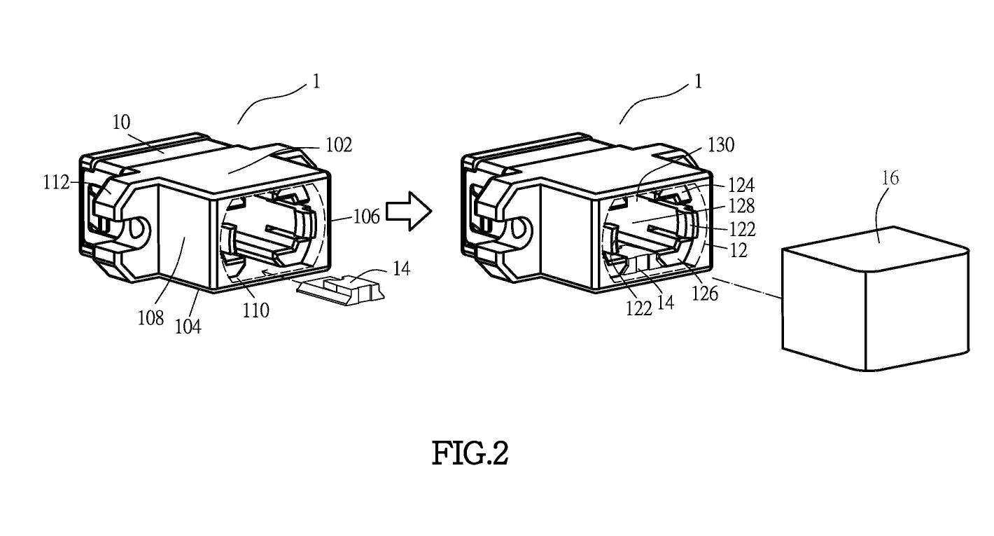

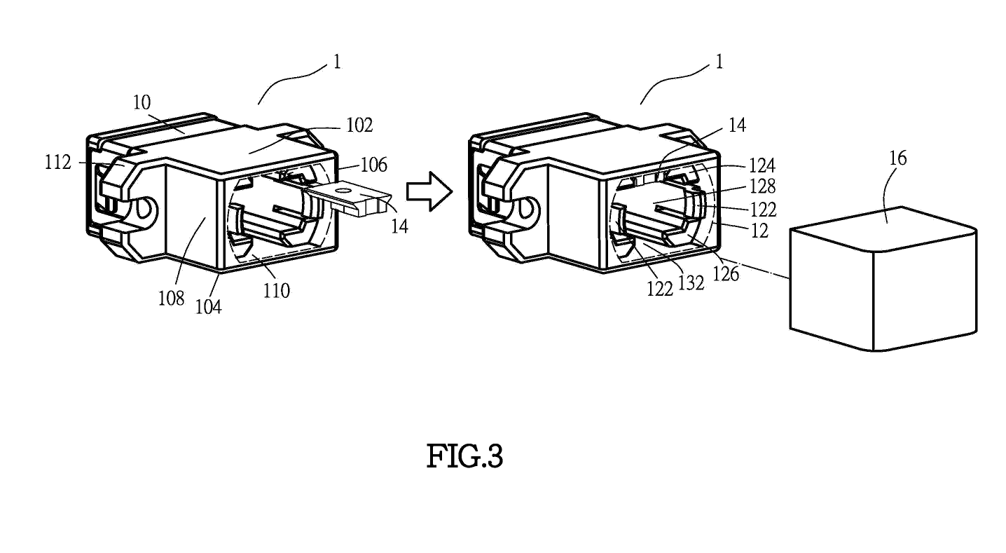

Please refer to FIG. 2 and FIG. 3, showing perspective views of an embodiment of a MPO optical fiber cable adapter of the present invention having different polarities of Key-up-to-Key-down and Key-up-to-Key-up respectively. The MPO optical fiber cable adapter 1 mainly comprises: an outer housing 10, an inner housing 12, a polarity member 14 and a dust protective cover 16.

The outer housing 10 includes an axial chamber (not shown in the figures) formed by a top wall 102, a bottom wall 104, a right-side wall 106 and a left-side wall 108 circumferencing together. Two axial ends of the axial chamber includes an opening 110 formed thereon respectively; wherein the right-side wall 106 and the left-side wall 108 include a protruding edge 112 formed thereon respectively and used for securing the MPO optical fiber cable adapter 1 onto an object. In addition, in a preferred embodiment of the present invention, the material of an outer housing 10 can be an engineering plastic, and an outer shape of protruding edge 112 can be generally of a U-shape.

The inner housing 12, preferably being integrally formed with the outer housing 10 as one single piece, is formed inside the axial chamber of the outer housing 10 and includes two locking hooks 122 formed to extend from left and right two sides of each opening 110 correspondingly; upper and lower two sides thereof include an upper inner wall 124 and a lower inner wall 126 arranged opposite from each other; the upper inner wall 124 and the lower inner wall 126 as well as the plurality of locking hooks 122 co-define a receiving space 128 generally of a rectangular shape together; wherein the inner sides of the upper inner wall 124 and the lower inner wall 126 further include an upper concave slot 130 and a lower concave slot 132 formed thereon respectively. Furthermore, the plurality of locking hooks 122 are of an identical structure.

The polarity member 14 is having a width smaller than those of the upper concave slot 130 and the lower concave slot 132 and is thinly attached to the upper concave slot 130 and the lower concave slot 132, which is configured to be detachably replaced in parts by the user in order to allow the MPO optical fiber cable adapter 1 to be configured to reveal different polarities. When the user detaches the polarity member 14 with a simple tool or bare hands, followed by firmly inserting it into the lower concave slot 132, then the polarity of the MPO optical fiber cable adapter 1 revealed at this time is Key-up-to-Key-down type. On the other hand, when the user detaches the polarity member 14 with a simple tool or bare hands, followed by inserting it into the upper concave slot 130, then the polarity of the MPO optical fiber cable adapter 1 revealed at this time is Key-up-to-Key-up type.

The dust protective cover 16 is firmly attached to the opening 110 in order to prevent the dust from entering therein. According to a preferred embodiment of the present invention, an operational temperature for the MPO optical fiber cable adapter 1 is preferably between −40 degree −75 degree Celsius; and an environmental temperature for storage thereof is preferably between −45 degree −85 degree Celsius.

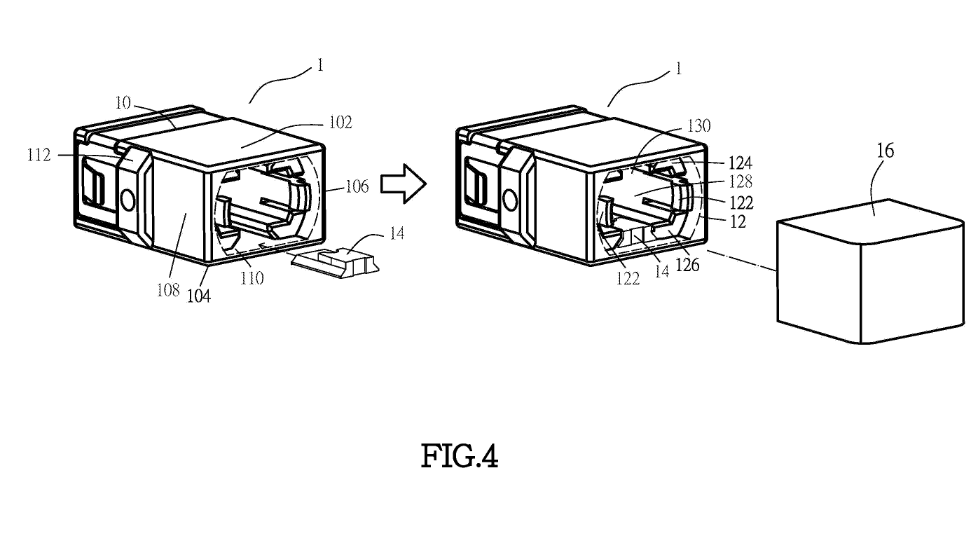

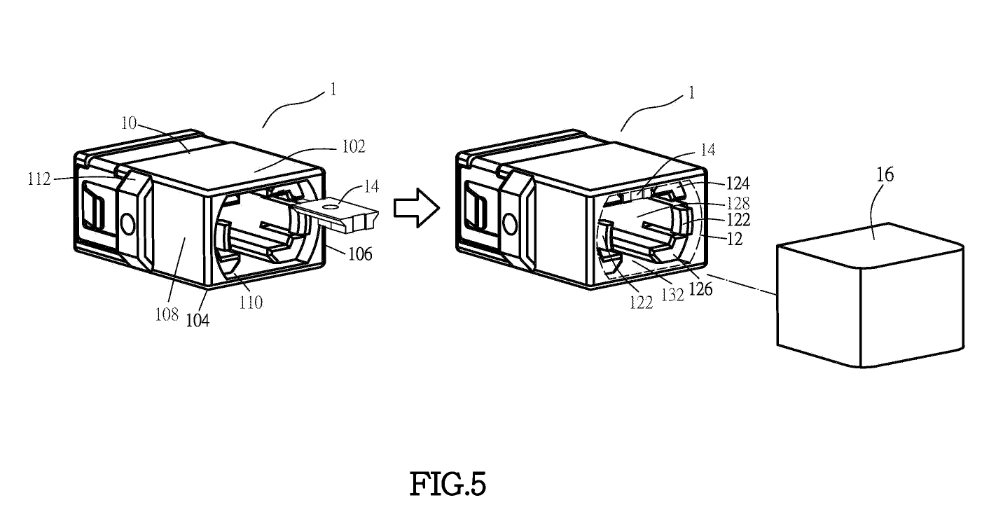

Please refer to FIG. 4 and FIG. 5, showing perspective views of another embodiment of a MPO optical fiber cable adapter of the present invention having different polarities of Key-up-to-Key-down and Key-up-to-Key-up respectively. The outer housing 10, the inner housing 12 and the polarity member 14 in this embodiment are identical to the ones of the previous embodiment mentioned above as shown in FIG. 2 and FIG. 3 and have been fully described in the above content; therefore, their details are omitted hereafter. The difference between the present embodiment and the previous embodiment shown in FIG. 2 and FIG. 3 is that the outer shape of the protruding edge 112 can be a trapezoid shape; wherein the outer shape of the protruding edge 112 can also be any one of a rectangular shape and an oval shape. Similarly, when the user detaches the polarity member 14 with a simple tool or bare hands, followed by firmly inserting it into the lower concave slot 132, then the polarity of the MPO optical fiber cable adapter 1 revealed at this time is Key-up-to-Key-down type. On the other hand, when the user detaches the polarity member 14 with a simple tool or bare hands, followed by inserting it into the upper concave slot 130, then the polarity of the MPO optical fiber cable adapter 1 revealed at this time is Key-up-to-Key-up-type.

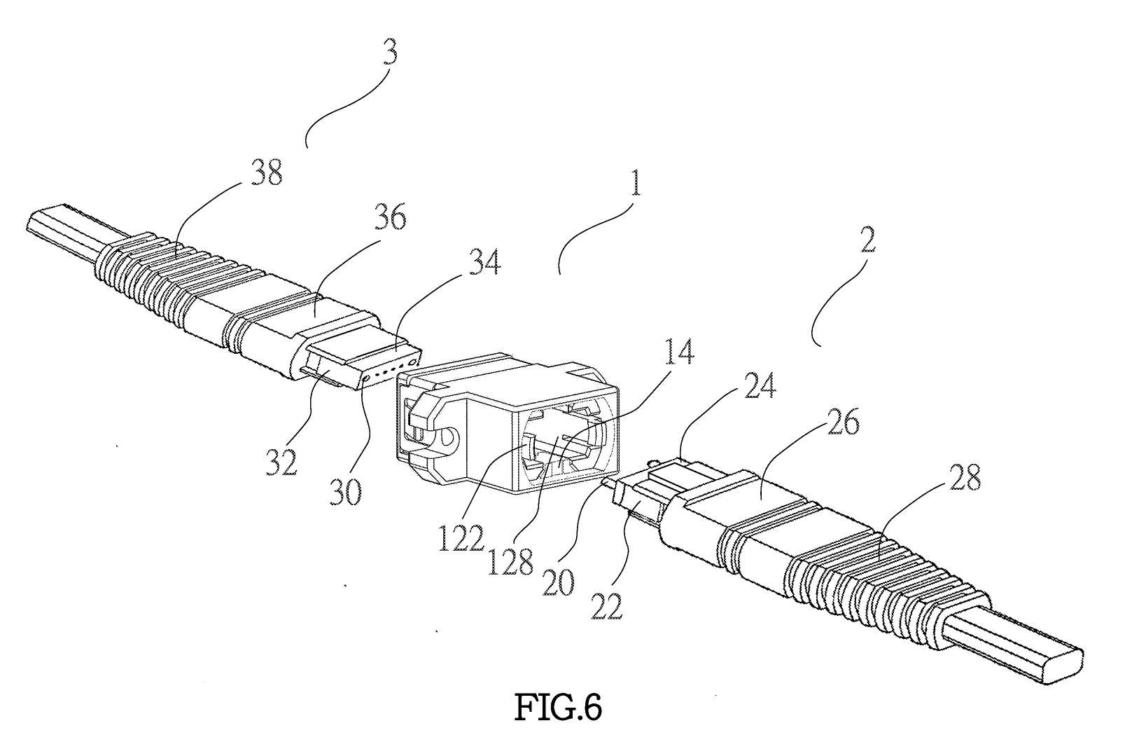

Please refer to FIG. 6, showing a perspective view of a MPO optical fiber cable adapter and MPO type optical fiber cable connectors. When the user has already confirmed the polarities of the MPO type optical fiber cable connectors 2, 3 and uses the polarity member 14 to change the polarities of the MPO optical fiber cable adapter 1, the MPO type optical fiber cable connectors 2, 3 can then be inserted into the corresponding receiving spaces 128 of the MPO optical fiber cable adapter 1 respectively. At this time, if an external force is exerted on the boot end 28 of the MPO type optical fiber cable connector 2 and the boot end 38 of the MPO type optical fiber cable connector 3 toward the direction of the MPO optical fiber cable adapter 1, then the plurality of locking hooks 122 on the MPO optical fiber cable adapter 1 are firmly locked onto the plurality of concave portions 22 on the MPO type optical fiber cable connector 2 and the plurality of concave portions 32 on the MPO type optical fiber cable connector 3 without any chance of coming off; in addition, the guiding pin 20 of the MPO type optical fiber cable connector 2 is able to be inserted into the guiding hole 30 of the MPO type optical fiber cable connector 3 as well. During the same time, a ferrule 24 of the MPO type optical fiber cable connector 2 is in contact with a ferrule 34 of the MPO type optical fiber cable connector 3 in order to achieve the connection between optical fiber cables. Since an elastic member 26 of the MPO type optical fiber cable connector 2 and an elastic member 36 of the MPO type optical fiber cable connector 3 both include springs at the internal structure thereof, in order to disengage the MPO type optical fiber cable connectors 2, 3 from the MPO optical fiber cable adapter 1, an external force is required to be exerted on the elastic member 26 of the MPO type optical fiber cable connector 2 and the elastic member 36 of the MPO type optical fiber cable connector 3 in a direction away from the MPO optical fiber cable adapter 1 in order to achieve the disengagement thereof with ease.

In comparison to the conventional optical fiber cable adapter, the MPO optical fiber cable adapter provided by the present invention has significant advantages. First, under the premise that there is no need for additional special or custom-made tools, the user can utilize the polarity member configured in the present invention to change the polarities of the MPO optical fiber cable adapter with ease and convenience according to the needs of the polarity of the optical fiber connector to be attached thereto. Secondly, it is able to prevent the stock and storage of different types of optical fiber cable adapters and to overcome the problem associated with user's wrong purchases due to incorrect understanding and distinguishing of the polarities of adapters.

The abovementioned embodiments are provided to illustrate the principles and exemplary methods of manufacturing or formation method of the present invention only. The scope of the present invention shall be defined by the claims recited hereafter, and any modifications or variations to the terms or wordings recited in the claims shall be considered as their relevant equivalence and are within the scope of the present invention. The scope of the present invention shall be determined by the content of the claims recited hereafter.

1. An MPO optical fiber cable adapter for connecting with two optical fiber cable connectors, comprising:
an outer housing having an axial chamber formed by a top wall, a bottom wall, a right-side wall and a left-side wall circumferencing together; two axial ends of the axial chamber having an opening formed thereon respectively; wherein the right-side wall and the left-side wall include a protruding edge formed thereon respectively and used for securing the MPO optical fiber cable adapter onto an object;
an inner housing disposed inside the axial chamber of the outer housing and having two locking hooks formed to extend from left and right two sides of each opening respectively; upper and lower sides thereof having an upper inner wall and a lower inner wall arranged opposite from each other; the upper inner wall and the lower inner wall as well as the plurality of locking hooks co-defining a receiving space generally of a rectangular shape together; wherein inner sides of the upper inner wall and the lower inner wall further include an upper concave slot and a lower concave slot formed thereon respectively;
a polarity member having a width smaller than those of the upper concave slot and the lower concave slot and firmly attached to the upper concave slot or the lower concave slot, configured to be detachably replaced in parts by the user in order to allow the MPO optical fiber cable adapter to be configured to reveal different polarities; and
a dust protective cover firmly attached to the plurality of openings in order to prevent dust from entering therein.

2. The MPO optical fiber cable adapter as claimed in claim 1, wherein the outer housing is of an engineering plastic material.

3. The MPO optical fiber cable adapter as claimed in claim 1, wherein the plurality of protruding edges are of a shape of any one of a trapezoid shape, a U-shape, a rectangular shape and an oval shape.

4. The MPO optical fiber cable adapter as claimed in claim 1, wherein the inner housing and the outer housing are integrally formed as one single piece.

5. The MPO optical fiber cable adapter as claimed in claim 1, wherein each of the optical fiber cable connectors comprises two concave portions for connecting with the plurality of locking hooks respectively.

6. The MPO optical fiber cable adapter as claimed in claim 1, wherein the plurality of locking hooks have an identical structure.

7. The MPO optical fiber cable adapter as claimed in claim 1, wherein the plurality of optical fiber cable connectors are MPO type optical fiber cable connectors.

8. The MPO optical fiber cable adapter as claimed in claim 1, wherein an operational temperature for the MPO optical fiber cable adapter is preferably between −40 degree −75 degree Celsius; and an environmental temperature for storage thereof is preferably between −45 degree −85 degree Celsius.
